(19) United States
(12) Patent Application Publication
(10) Pub. No.: US 2020/0259330 A1
(43) Pub. Date: Aug. 13, 2020

(54) ENERGY STORAGE SYSTEM WITH STRING BALANCE FUNCTION

(71) Applicant: GENERAL ELECTRIC COMPANY, Schenectady, NY (US)

(72) Inventors: Dong Dong, Niskayuna, NY (US); Zhi Zhou, Selkirk, NY (US); Tomas Sadilek, Schenectady, NY (US); Herman Lucas Norbert Wiegman, Essex Junction, VT (US)

(21) Appl. No.: 16/614,591

(22) PCT Filed: May 11, 2018
(86) PCT No.: PCT/US18/32363

§ 371 Date: Nov. 18, 2019

(51) Int. Cl. H02J 3/32; H02J 7/00

(52) U.S. Cl. CPC H02J 3/32; H02J 7/0018

(57) ABSTRACT

An energy storage system includes an energy storage device that has a plurality of cells. The energy storage system further includes a string power converter connected in series between the energy storage device and a direct current (DC) bus, and a plurality of cell power converters each connected across a respective one of the energy storage device cells.

### CROSS-REFERENCE TO RELATED APPLICATION

This application claims the benefit of U.S. Provisional Patent Application No. 62/513,020, filed on May 31, 2017, the contents of which are hereby incorporated by reference for all purposes.

This invention was made with Government support under contract number N00014-15-C-5082 awarded by the U.S Navy. The Government has certain right in this invention.

### BACKGROUND

This invention relates generally to control of an energy storage system and, more specifically, to balancing parallel battery strings in the energy storage system.

The worldwide demand for electrical energy has been increasing year by year. Most of the electrical energy demand is met by energy produced from conventional energy sources such as coal, oil and gas. However, in recent years, with the rising global climate change issues, there has been a push for electricity generation by renewable energy resources such as solar power and wind power.

Wind turbine generators are regarded as environmentally friendly and relatively inexpensive alternative sources of energy that utilize wind energy to produce electrical power. Further, solar power generation uses photovoltaic (PV) modules to generate electricity from sunlight. Since the intensity of wind and sunlight is not constant, the power output of wind turbines and PV modules fluctuates throughout the day. Unfortunately, the demand for electricity does not vary in accordance with solar and wind variations.

Energy storage systems may help to address the issue of variability of solar and wind power. Essentially, the variable power from solar and wind power plants can be stored in the energy storage system which can then be used at a later time or at a remote location. Energy storage systems may also be charged from a power network and could be used to address the frequency variations, harmonic suppression, voltage support and power quality in the power network.

Electrical energy storage systems generally include batteries, power electronics and a controller. In one arrangement, a plurality of batteries may be connected in parallel to a common DC bus in the energy storage system. In such an arrangement, the energy storage system may not operate optimally due to mismatches between battery voltages and capacities as the battery cells age or are exposed to different thermal gradients. This can also lead to current circulation between batteries degrading and/or damaging the batteries. Moreover, in each of the batteries there may be a plurality of battery cells which are connected in series and/or in parallel. If these battery cells are operating at different voltages then they may not support the load equally affecting the overall performance.

Therefore, a system and a method that will address the foregoing issues is desirable.

### BRIEF DESCRIPTION

In some embodiments, an energy storage system includes a battery that has a plurality of battery cells. The energy storage system also includes a string power converter connected in series between the battery and a direct current (DC) bus. Further, the energy storage system includes a plurality of cell power converters each connected across a respective one of the battery cells.

### BRIEF DESCRIPTION OF THE DRAWINGS

These and other features and aspects of embodiments of the present invention will become better understood when the following detailed description is read with reference to the accompanying drawings in which like characters represent like parts throughout the drawings, wherein:

FIG. 1 illustrates a schematic diagram representing an energy storage system in accordance with an embodiment of the present invention;

FIG. 2 illustrates a schematic diagram of a section of the energy storage system in accordance with an embodiment of the present invention;

FIG. 3 illustrates a schematic diagram of another energy storage system in accordance with an embodiment of the present invention;

FIGS. 4A and 4B each illustrate a schematic diagram of a respective example of a string power converter in accordance with an embodiment of the present invention;

FIGS. 5A and 5B each illustrate a schematic diagram of a respective example of a cell power converter in accordance with an embodiment of the present invention;

FIG. 6 illustrates a block diagram representing a controller in accordance with an embodiment of the present invention; and

FIG. 7 is a flow chart that represents a process in accordance with an embodiment of the present invention.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

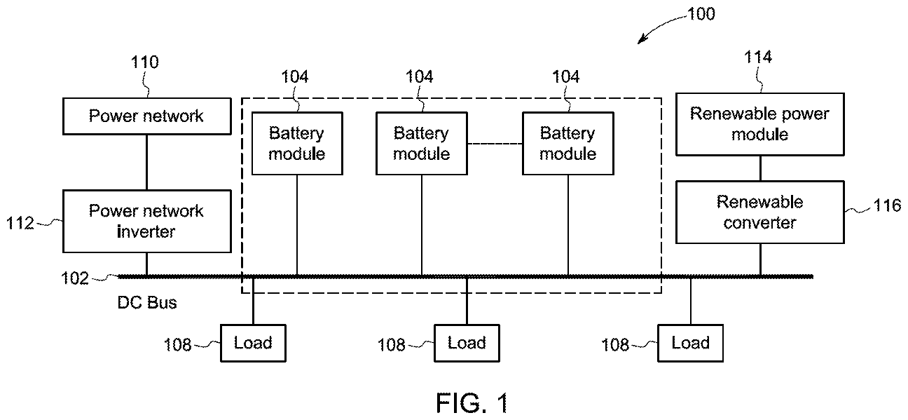

FIG. 1 shows an energy storage system 100 according to aspects of the present disclosure. The energy storage system 100 includes a DC bus 102. A plurality of battery modules 104 is connected to the DC bus. Each of the plurality of battery modules includes a battery having a plurality of battery cells connected in series and/or parallel and at least one power converter. The batteries in the battery module 104 may get charged from the DC bus 102 or may provide energy to loads 108 connected to the DC bus 102. The power converters in the battery module 104 may facilitate transfer of energy from one battery module 104 to another battery module 104 or from one battery cell to another battery cell within one battery module 104. The energy storage system 100 may also include other components such as a controller (not shown in FIG. 1), a communication module (not shown) and a protection module (not shown). Moreover, examples of the loads 108 may include a car charger, electric drives, lighting loads, etc. (all not separately shown). When the loads are alternating current (AC) loads, a DC to AC converter may be used between the DC bus 102 and the loads 108.

In one embodiment, the energy storage system 100 may be connected to power network 110 via a power network side inverter 112. The power network 110 could be a consumer, commercial, and/or utility scale power network. In another embodiment, the energy storage system 100 may also be connected to a renewable power module 114 which, in one embodiment may include PV panels for generating solar power. The renewable power module 114 is connected to the energy storage system via a renewable converter 116. In an embodiment where the renewable power module includes PV panels, the renewable converter 116 may be a photovoltaic (PV) converter. By controlling the DC bus voltage, batteries 104 may be charged from power network 110 and renewable power module 114. It should be noted that the connection of the energy storage system 100 to both power network 110 and renewable power module 114 is optional. For example, in some embodiments, only power network 110 may be connected to the energy storage system 100 or only renewable power module 114 may be connected to the energy storage system 100. Moreover, the energy storage system 100 may be selectively coupled to the power network 110 and the renewable power module 114 via control circuitry such that a given installation may be coupled to one or both of the power network 110 and renewable power module 114 dynamically based on installation and/or application to provide added flexibility. In yet another embodiment, a wind turbine or any other renewable generation source may be coupled to the DC bus 102 via the renewable power converter 116 to charge the batteries 104.

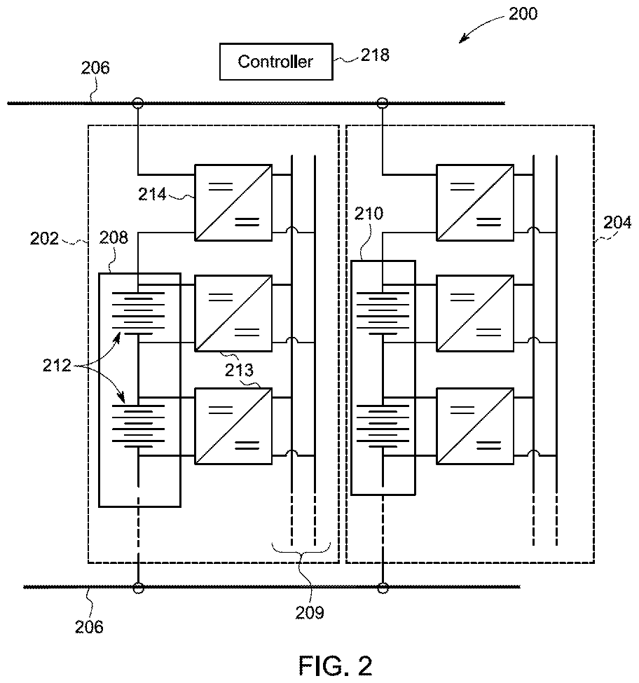

FIG. 2 shows a section 200 of the energy storage system 100 according to aspects of the present disclosure. The energy storage system 200 includes a plurality of battery modules 202, 204 coupled to a first DC bus 206. Each of the battery modules 202, 204 include a battery 208 or 210 respectively. Moreover, each of the batteries (e.g., battery 208) include a plurality of battery cells 212 connected in series/parallel. Each of the battery cells 212 is connected to a second DC bus 209 via a cell power converter 213. In one embodiment, some battery cells 212 which are connected in series/parallel are together connected to a second DC bus 209 via cell power converter 213. A controller 218 controls the cell power converters 213 to maintain a battery cell voltage of the battery cell 212 at a desired reference voltage. The desired reference voltage may be determined based on operating conditions of the energy storage system 200. In one embodiment, the desired reference voltage for a given battery cell may be determined by dividing the DC bus voltage value by total number of battery cells in the battery module containing the given battery cells.

It should be noted that while controlling the reference voltage of battery cells, the cell power converters are essentially exchanging energy therebetween. For example, if a first battery cell has lesser voltage than a second battery cell then the corresponding cell power converters will transfer some energy from the second battery cell to the first battery cell. It should also be noted that the controller 218 is a master controller (i.e., central controller) for the entire energy storage system 200 (control connections not shown). However, in another embodiment the control function of controlling the converters could be performed by a slave controller (i.e., a local controller) for each of the battery modules. It should be noted that although only one of the battery modules is explained in detail here, the other battery module 204 has a substantially similar structure.

The battery module 202 further includes a string power converter 214 to couple the battery 208 to the first DC bus 206. In one embodiment, the string power converter 214 is coupled to the second DC bus 209 on one side and is connected in series between the battery and the first DC bus 206 on another side. Thus, the string power converter 214 adds a DC voltage between the battery module 202 and the first DC bus 206. For example, the DC bus voltage may be Vbus=V1+V2, where V1 is the voltage across battery 208 and V2 is the DC voltage added by the string converter 214. It should be noted that voltage V2 could be a positive or a negative voltage. The controller 218 controls switching of string power converter 214 so as to control the DC voltage added by the string converter 214. By controlling the DC voltage V2, a current through the battery module 202 may thus be controlled. Since there is ability to control currents through battery modules, the degradation of batteries due to current circulations between the batteries can be avoided with this invention.

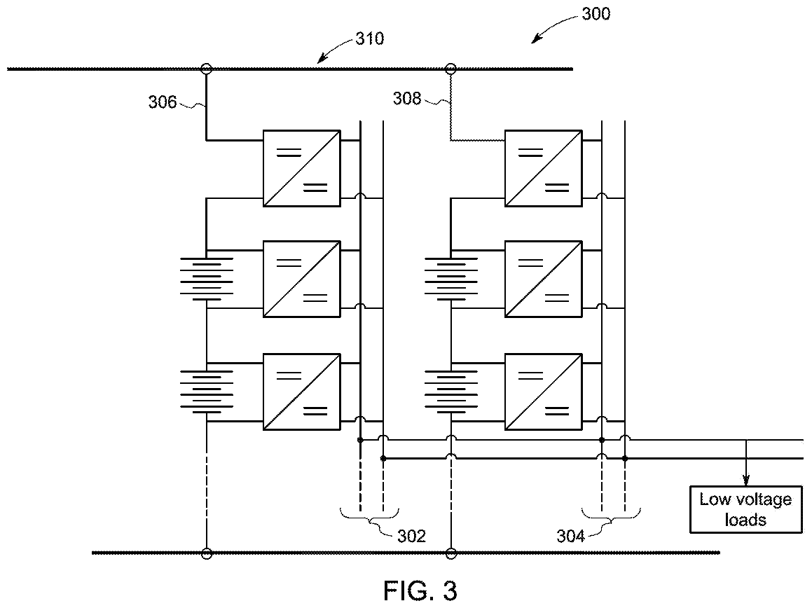

FIG. 3 shows another embodiment 300 of the energy storage system. In the embodiment shown, the second DC buses 302, 304 of the battery modules 306, 308 are connected to each other. With this embodiment, energy from battery cells in one battery module may be transferred to battery cells in another battery module. This adds an additional flexibility to the system. Moreover, the interconnected second DC buses 302, 304 can then be used to supply power to low voltage loads whereas the first DC bus 310 can be used to supply power to high voltage loads.

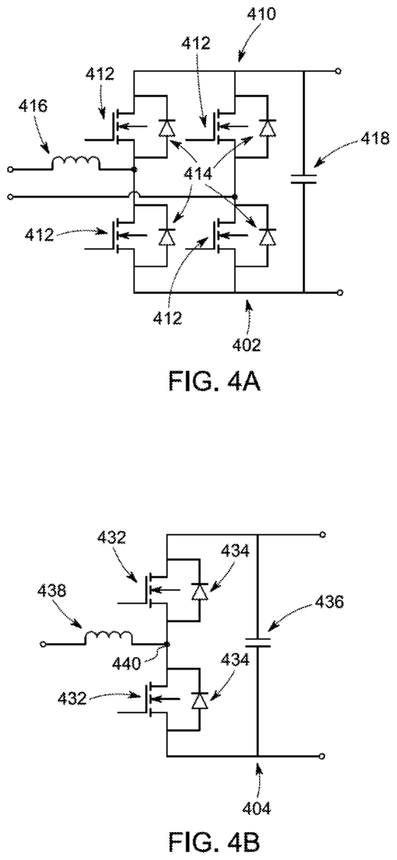

FIG. 4A shows a first example embodiment of the string power converter 214 of FIG. 2. In general, string power converter 214 may include a bidirectional non-isolated power converter or a bidirectional isolated power converter. Further, in the example shown in FIG. 4A, the string power converter may be embodied as a bidirectional full-bridge converter 402. The design of a bidirectional full-bridge converter is generally well within the ability of those who are skilled in the art. Nevertheless, some details of the power converter embodiment 402 will now be pointed out. Referring then to FIG. 4A, a full bridge arrangement 410 of field effect transistors (FETs) 412 and diodes 414 is coupled between an inductor 416 and a capacitor 418.

FIG. 4B shows another example embodiment of the string power converter 214 of FIG. 2. In the example shown in FIG. 4B, the string power converter may be embodied as a bidirectional buck converter 404. The design of a bidirectional buck converter is generally well within the ability of those who are skilled in the art. Nevertheless, some details of the power converter embodiment 404 will now be pointed out. Referring to FIG. 4B, FETs 432 and diodes 434 are arranged in parallel with a capacitor 436. An inductor 438 is coupled at a junction 440 of the FETs and the diodes.

In other embodiments, the string power converter may be provided as a bidirectional buck boost converter or another type of DC/DC converter in addition to those already mentioned. For example, the string power converter may be of an isolated type instead of the non-isolated examples that are shown.

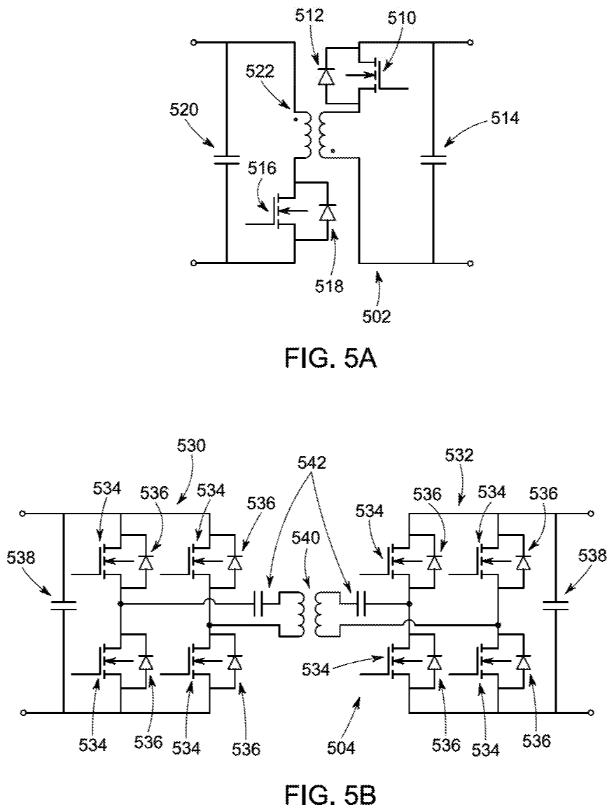

FIG. 5A shows a first example embodiment of the cell power converter 213 of FIG. 2. In general, cell power converter 213 may include a bidirectional isolated power converter. Further, in the example shown in FIG. 5A, the cell power converter may be embodied as a bidirectional flyback converter 502. The design of a bidirectional flyback converter is generally well within the ability of those who are skilled in the art. Nevertheless, some details of the power converter embodiment 502 will now be pointed out. Referring to FIG. 5A, FET 510, diode 512 and capacitor 514 are isolated from FET 516, diode 518 and capacitor 520 by isolating transformer 522.

FIG. 5B shows another example embodiment of the cell power converter 213 of FIG. 2. In the example shown in FIG. 5B, the cell power converter may be embodied as a bidirectional LLC resonant converter 504. The design of a bidirectional LLC resonant converter is generally well within the ability of those who are skilled in the art. Nevertheless some details of the power converter embodiment 504 will now be pointed out. Referring to FIG. 5B, full bridge arrangements 530 and 532 of FETs 534 and diodes 536 are each associated with a respective capacitor 538. The full bridge arrangements 530 and 532 are isolated from each other by an isolating transformer 540. The circuit also includes capacitors 542.

In other embodiments, the cell power converter may be provided as a dual active bridge converter or another type of DC/DC converter in addition to those already mentioned.

While example power converters illustrated in the drawings include MOSFETs, this is not intended to be limiting; power converters that do not use MOSFETs may alternatively be employed.

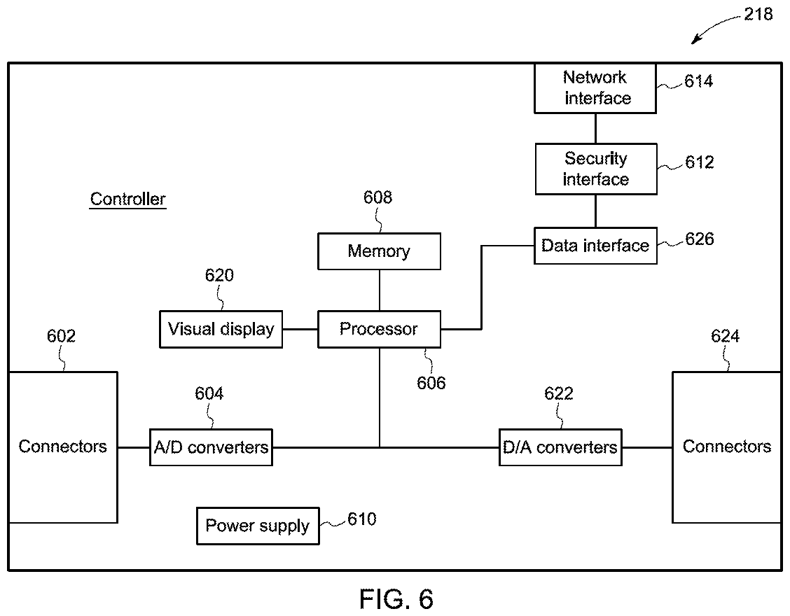

Referring now to FIG. 6, there is shown a block diagram illustrating one embodiment of a local controller 218 as used in the energy management system. In particular, the local controller 218 includes each of the following elements: a plurality of connectors 602 for receiving external inputs; an analog to digital converter 604 for converting received analog signals into digital signals; a processor 606 for performing any signal processing required by the controller 218; a memory 608 operatively connected to the processor 606 for storing information on the controller 218 and also for storing program instructions for controlling the processor 606; a power supply 610 for providing required power to the processor 606 and other elements (power connections not shown); a security interface 612 and a network interface 614 for enabling transmission and receipt of information to the cloud controller (not shown) and/or other local controllers (not shown); and a visual display 620, coupled to the processor 606 for enabling the controller 218 to indicate current status or other information visually. The local controller 218 may also include a digital to analog converter 622 for converting digital signals into analog signals to control the power converters, the analog control signals being outputted from the controller 218 via connectors 624. A data interface 626 is connected between the processor 606 and the security interface 606 to facilitate the exchange of data between the processor 606 and external digital devices (not shown).

The controller 218 may control the string power converter and the cell power converters to function as described herein.

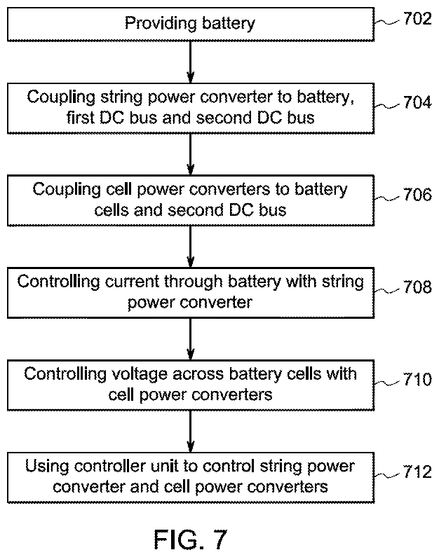

FIG. 7 is a flow chart that represents a process in accordance with an embodiment of the present invention.

At 702 in FIG. 7, a battery is provided.

At 704, a string power converter is coupled to the battery, to a first DC bus and to a second DC bus.

At 706, cell power converters are coupled to the second DC bus and to battery cells that make up the battery.

At 708, current through the battery is controlled with the string power converter.

At 710, voltage is controlled across the battery cells with the cell power converters.

At 712, the controller 218 controls the string power converter and the cell power converters.

The above descriptions and illustrations of processes herein should not be considered to imply a fixed order for performing the process steps. Rather, the process steps may be performed in any order that is practicable, including the omission of one or more steps and/or the simultaneous performance of at least some steps.

In operation, current may flow through the bus 209 (FIG. 2) via the cell power converters 213 to the string power converter 214. Through operation of the cell power converters 213, the battery cells 212 are maintained at equal voltages and equal cell charges. Connecting the battery 208 to the bus 206 via the string power converter 214 makes it unlikely that there will be any risk of damage to the battery. Battery life is likely to be enhanced and risks of uneven/non-uniform degradation of the battery are likely to be reduced.

The bus 206 may be coupled to high voltage loads and the bus 209 may be coupled to low voltage loads. In some embodiments, the voltage at the bus 206 may be five times or more than five times the voltage at the bus 209.

A technical effect of the invention is to improve performance and operability of electrical energy storage systems, particularly of the ones with multiple paralleled strings and multiple paralleled and/or in series cells in one string. The invention also supports adding new battery strings alongside old battery strings in previously existing energy storage systems.

The energy storage system 100 is illustrated in FIG. 1 as being installed in conjunction with a renewable energy source, such as a wind turbine and/or a photovoltaic (PV) array. Alternatively, or in addition, an energy storage system as disclosed herein may be installed in an electric vehicle (EV), in a hybrid electric vehicle (HEV), in a so-called “green building” (i.e., a building with reduced energy usage as compared to conventional buildings), as part of the power supply for a data center, as part of an uninterrupted power supply for various applications, and/or in various transportation or aviation applications.

In the above description, the energy storage systems were illustrated with examples in which the energy storage functions were performed by batteries. It is further contemplated in other embodiments, however, that ultracapacitors may be used in place of some or all of the batteries. For example, in some embodiments, the energy storage system may include at least one string of batteries, and at least one string of ultracapacitors. At this point, the term “energy storage device” will now be introduced. This term, as used in this document including the claims, should be understood to refer to either or both of batteries and ultracapacitors.

This written description uses examples to explain the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An energy storage system comprising:
an energy storage device having a plurality of energy storage device cells;
a string power converter connected in series between the energy storage device and a direct current (DC) bus; and
a plurality of cell power converters each connected across a respective one of the energy storage device cells.

2. The energy storage system of claim 1, wherein the DC bus is a first DC bus;
the energy storage system further comprising a second DC bus, said cell power converters connected between the second DC bus and the energy storage device cells.

3. The energy storage system of claim 2, wherein the string power converter is connected between the first DC bus and the second DC bus.

4. The energy storage system of claim 3, wherein:
said first DC bus is at a first voltage level; and
said second DC bus is at a second voltage level, said first voltage level at least five times said second voltage level.

5. The energy storage system of claim 1, wherein each of the cell power converters includes an isolated power converter.

6. The energy storage system of claim 1, wherein each of the cell power converters is a bidirectional flyback converter or a bidirectional LLC resonant converter.

7. The energy storage system of claim 1, wherein the string power converter controls a current through the energy storage device.

8. The energy storage system of claim 1, wherein each of the cell power converters controls voltage across a corresponding one of the energy storage device cells.

9. The energy storage system of claim 1, wherein the energy storage device is a battery and the energy storage device cells are battery cells.

10. The energy storage system of claim 1, wherein the energy storage device is an ultracapacitor and the energy storage device cells are ultracapacitor cells.

11. An energy storage system comprising:
a first direct current (DC) bus;
a plurality of energy storage device modules coupled to the first DC bus, wherein each of the plurality of energy storage device modules comprises:
an energy storage device having a plurality of energy storage device cells;
a second DC bus;
a string power converter coupled to the second DC bus on one side and connected in series between the energy storage device and the first DC bus on another side; and
a plurality of cell power converters to couple the plurality of energy storage device cells to the second DC bus.

12. The energy storage system of claim 11, wherein the string power converter controls a current through the respective energy storage device module.

13. The energy storage system of claim 11, wherein each of the plurality of cell power converters controls voltage across each of the respective energy storage device cells.

14. The energy storage system of claim 11, wherein each of the plurality of cell power converters includes a bidirectional isolated power converter.

15. The energy storage system of claim 11, wherein the bidirectional isolated power converter includes a bidirectional flyback converter or a bidirectional LLC resonant converter.

16. The energy storage system of claim 11, wherein the string power converter includes a bidirectional non-isolated power converter or a bidirectional isolated power converter.

17. The energy storage system of claim 11, wherein the bidirectional non-isolated power converter includes a bidirectional full-bridge converter or a bidirectional buck converter.

18. The energy storage system of claim 11, wherein the second DC buses of each of the plurality of energy storage device modules are connected to each other.

19. A method comprising:
providing an energy storage device that includes a plurality of energy storage device cells;
controlling a current through the energy storage device with a string power converter; and
controlling, with a respective cell power converter, a respective voltage across each of the energy storage device cells.

20. The method of claim 19, further comprising:
controlling the string power converter and the cell power converters with a controller unit.

21. The method of claim 19, further comprising:
coupling the string power converter between a first direct current (DC) bus and a second DC bus.

22. The method of claim 21, further comprising:
coupling the cell power converters to the second DC bus.
